(19) United States
(12) Patent Application Publication
(10) Pub. No.: US 2026/0175876 A1
(43) Pub. Date: Jun. 25, 2026

(54) AUTONOMOUS VEHICLE SAFETY OPERATION MODES

(71) Applicant: Zoox, Inc., Foster City, CA (US)

(72) Inventors: Matthew Nathaniel Dickerson, San Francisco, CA (US); Marcello Daniele Guarro, Santa Cruz, CA (US); Clement Ching-Fai Lee, San Jose, CA (US); Latheepan Murugathasan, Dublin, CA (US); Carter Scott Pearson, Foster City, CA (US); Michal Piotr Romanko, Lexington, MA (US); Eric Yu-Chieh Shyu, Broomfield, CO (US); Keith Ong Soneda, Oakland, CA (US); Akilla Srikrishna, Foster City, CA (US); Martin Stiaszny, El Cerrito, CA (US); Yongguang Zhu, Yorktown, VA (US)

(21) Appl. No.: 18/991,167

(22) Filed: Dec. 20, 2024

(51) Int. Cl. B60W 60/00; B60W 50/02; B60W 50/029

(52) U.S. Cl. CPC B60W 60/0015; B60W 50/0205; B60W 50/029

(57) ABSTRACT

Techniques are discussed herein for the use of multiple different autonomous safety operation modes. The different safety operation modes can be used by a backup motion compute node (MCN) of an autonomous vehicle, so that the backup MCN is prepared to perform safety operations according to an applicable safety operation mode. In a first safety operation mode, the autonomous vehicle can respond to emergencies or fault conditions by following generated safety operation trajectories. The generated safety operation trajectories can include, e.g., moderate braking and active steering. In contrast, in a second safety operation mode, the autonomous vehicle can respond to emergencies or fault conditions by following preset steering and braking settings.

### BACKGROUND

Autonomous vehicles may be equipped with a variety of safety features, including the ability to undertake safety operations such as emergency stops. Safety operations can be made under various circumstances, e.g., in response to significant vehicle system faults which may render continued vehicle movement unsafe.

The ability to undertake safety operations is essential for autonomous vehicles. However, implementing autonomous vehicle safety operation capabilities can present difficult technical problems.

For example, safety operation capabilities should be robust and tolerant of multiple different fault types, and therefore safety operation capability design should have limited or reduced dependencies. On the other hand, different driving scenarios can call for different safety operation maneuvers, and so it is also preferable to use an autonomous vehicle's ability to maneuver through a safety operation, if such ability remains available.

### BRIEF DESCRIPTION OF THE DRAWINGS

FIG. 1 is a flow diagram illustrating an example process for an autonomous vehicle to respond to a safety operation trigger according to an applicable vehicle state, in accordance with one or more examples of the disclosure.

FIG. 2 is a pictorial diagram illustrating an example state transition of an autonomous vehicle which experiences a component fault, wherein different vehicle states are configured to apply different safety operation modes, in accordance with one or more examples of the disclosure.

FIGS. 3A-3B are pictorial diagrams illustrating different example safety operation modes for the autonomous vehicle introduced in FIG. 2, in accordance with one or more examples of the disclosure.

FIG. 4 is a block diagram illustrating an example computing architecture for an autonomous vehicle configured to apply different safety operation modes, in accordance with one or more examples of the disclosure.

FIG. 5 is a block diagram illustrating example operations of a backup motion compute node (MCN) and a primary MCN in connection with applying different safety operation modes, in accordance with one or more examples of the disclosure.

FIG. 6 is a block diagram of an example system including an autonomous vehicle, in accordance with one or more examples of the disclosure.

FIG. 7 is a flow diagram illustrating an example process for an autonomous vehicle to switch between different vehicle states, the different vehicle states having different safety operation modes, in accordance with one or more examples of the disclosure.

### DETAILED DESCRIPTION

This disclosure describes techniques for autonomous vehicles to use multiple different safety operation modes. The different safety operation modes can be used by a backup motion compute node (MCN) of an autonomous vehicle, so that the backup MCN is prepared to perform safety operations according to an applicable safety operation mode. In a first safety operation mode, the autonomous vehicle can respond to emergencies or fault conditions by following generated safety operation trajectories. The generated safety operation trajectories can include, e.g., moderate braking and active steering. In contrast, in a second safety operation mode, the autonomous vehicle can respond to emergencies or fault conditions by following preset steering and braking settings.

An emergency stop is one type of safety operation, and emergency stops are used throughout this disclosure as an example safety operation. However, other safety operations such as turns, accelerations, decelerations, following safe routes, and deployment of passenger protection devices such as airbags, are also safety operations that may be applied differently in different safety operation modes, in accordance with embodiments of this disclosure.

The different safety operation modes presented herein can be applied in the context of a variety of different autonomous vehicle system architectures. Therefore, the different safety operation modes will first be described in general, followed by an illustration of the different safety operation modes in the context of one example autonomous vehicle system architecture.

In general, an autonomous vehicle according to this disclosure can be equipped with at least two different safety operation modes, optionally in the form of two different safety operation modes. Different respective safety operation modes can be used in different vehicle states that result from different states of a backup MCN onboard the autonomous vehicle. The autonomous vehicle can monitor vehicle components to determine a vehicle state.

Circumstances that trigger a safety operation, such as a fault or failure of one or more critical vehicle systems, are referred to herein as safety operation triggers. In the event of a safety operation trigger, an autonomous vehicle can use a safety operation mode according to a determined vehicle state. For example, if the autonomous vehicle is in a first vehicle state when a safety operation trigger occurs, then the autonomous vehicle can use a first safety operation mode in response to the safety operation trigger. In contrast, if the autonomous vehicle is in a second vehicle state when the safety operation trigger occurs, then the autonomous vehicle can use an alternative, second safety operation mode in response to the safety operation trigger.

An example first safety operation mode may be referred to herein as a “no-go” type safety operation mode, while an example second safety operation mode may be referred to herein as a “safe stop” type safety operation mode. The no-go mode may make use of certain vehicle navigational capabilities during an emergency stop, which need not be relied upon in the safe stop mode. Therefore, the no-go mode may generally be a preferred stopping mode, and the no-go mode can be used when the autonomous vehicle has sufficient capability to use the no-go mode. On the other hand, the safe stop mode can remain available for circumstances in which vehicle capabilities used for the preferred no-go mode may be unavailable.

The example no-go mode can follow one or more trajectories generated for the autonomous vehicle. An example trajectory can be based on multiple factors such as vehicle velocity, vehicle turning angle, and vehicle environment. The example no-go mode can optionally comprise moderate braking. Moderate braking can comprise, e.g., a deceleration that is less than a vehicle's maximum deceleration. In some cases, moderate braking can be at least 10% below a vehicle's maximum deceleration.

The example no-go mode can furthermore optionally comprise active steering. Active steering is defined herein as using any steering angles other than the steering angle in use at the time of a safety operation trigger. Active steering can for example steer a vehicle through a curve in a road, or onto a roadway shoulder, or between other vehicles. Active steering can apply a sequence of different steering angles to navigate the vehicle through a turn or around obstacles.

In contrast with the no-go mode, an example safe stop mode can apply predetermined settings to stop an autonomous vehicle. The use of predetermined settings need not involve a generated trajectory such as used in the no-go mode. The predetermined settings can comprise any desired settings. In one example, the predetermined settings can maintain a steering angle that is in use at the time of a safety operation trigger. Furthermore, the predetermined settings can apply a substantially maximum braking/maximum deceleration of the vehicle to bring it to a stop. Other example predetermined settings can use, e.g., a straight (zero degree) steering angle and 50% of the vehicle's maximum deceleration, or any other desired settings. While the use of predetermined settings in the safe stop mode will result in a trajectory, such a trajectory is the result of the settings applied and need not be computed or generated in advance.

The “no-go” and “safe stop” modes disclosed herein are examples of alternative safety operation modes. However, this disclosure is not limited to the “no-go” and “safe stop” modes. Instead, implementations of this disclosure can optionally include safety operation modes which apply other alternative safety operations. Alternative safety operations can include alternative emergency operations, alternative elevated/heightened awareness operations, alternative fault detection modes, alternative safe modes, alternative safety and data preserving operations, and alternative stopping operations which may apply different decelerations. Alternative stopping operations can include hard, maximum braking complete stops, or any more moderate lower deceleration stops. Some alternative safety operations may slow the vehicle without stopping it. Other alternative safety operations may change a vehicle route or apply a timer or distance range for a future route change, without necessarily bringing the vehicle to a stop.

The autonomous vehicle can monitor vehicle components to determine a vehicle state, as noted above. For example, the autonomous vehicle can remain in a first vehicle state, in which the first safety operation mode is used to respond to safety operation triggers, while monitoring one or more components that may be involved in safety operations according to the first safety operation mode. If any of the monitored components experiences a fault, the autonomous vehicle can transition into a second vehicle state in which the second safety operation mode is used to respond to safety operation triggers.

Vehicle components can be monitored in any desired approach, and some implementations can monitor data used by the vehicle, whether such data is output directly or indirectly by vehicle components or consumed by vehicle components. For example, the autonomous vehicle can monitor for trajectory faults, inertia measurement unit (IMU) data faults, global pose data faults, local pose data faults, backup motion compute node (MCN) internal faults, braking faults, steering faults, and/or velocity faults. Any other faults, data, or other elements can be monitored as desired for particular implementations.

Turning now to the implementation of different stopping modes within an example autonomous vehicle system architecture, an autonomous vehicle may comprise multiple computer systems, including, e.g., at least one computer system hosting a primary compute node (PCN) and at least two additional computer systems hosting MCNs. The MCNs can include a first, active (or primary) MCN and a second, backup MCN.

In general, the PCN can be configured to perform environment perception via sensors, and the PCN can compute vehicle trajectories. The active MCN can control the autonomous vehicle according to the trajectories computed by the PCN. The backup MCN can be configured to implement safety operations such as emergency stops of the autonomous vehicle in the event of safety operation triggers such as a fault or failure at the active MCN. Therefore, an example safety operation trigger in a system architecture comprising a PCN, an active MCN, and a backup MCN can comprise a fault or failure at the active MCN, which can cause the backup MCN to assume control of the autonomous vehicle and bring the autonomous vehicle to an emergency stop according to an applicable safety operation mode. The term “vehicle stopping fault” may be used herein to refer to one type of safety operation trigger, namely, a safety operation trigger that triggers an emergency stop.

A backup MCN can monitor multiple autonomous vehicle components and vehicle data for faults, errors, or failures. In a first vehicle state, a backup MCN of an autonomous vehicle may detect that the monitored components are functioning “normally” or “nominally” without faults or errors.

In the event of a safety operation trigger while in the first vehicle state, the backup MCN can assume control of the autonomous vehicle and stop the vehicle according to the first safety operation mode, e.g., according to the no-go mode described herein, or any other desired first safety operation mode. In order to stop the autonomous vehicle according to a first safety operation mode that makes use of one or more trajectories computed by the PCN, the backup MCN can be equipped with components and functions, described herein, to enable the backup MCN to control the autonomous vehicle according to generated trajectories.

In the event a component fault or other fault is detected, and assuming such component fault does not itself comprise a safety operation trigger, the backup MCN can cause a transition of the backup MCN, and optionally a transition of the active MCN and/or PCN as well, into a second vehicle state. In the event of a safety operation trigger while in the second vehicle state, the backup MCN (or, optionally the active MCN) can assume control of the autonomous vehicle and stop the vehicle (or perform another alternative safety operation) according to the second safety operation mode, e.g., according to the safe stop mode described herein, or any other desired second safety operation mode. The backup MCN can be equipped with components and functions to enable stopping the vehicle according to the second safety operation mode without dependencies on trajectories from the PCN or on other vehicle functions or systems.

Furthermore, in some embodiments, a primary MCN and/or PCN of an autonomous vehicle can be configured to employ operational constraints when the backup MCN is in the second vehicle state. This disclosure is not limited to any specific operational constraints. By way of example, one optional constraint can comprise a passenger pickup constraint, which may restrict an autonomous vehicle from picking up additional passengers while in the second vehicle state. Another optional constraint can comprise a time and/or range constraint, which limits an amount of time and/or a distance range of an autonomous vehicle while in the second vehicle state. The autonomous vehicle can be configured to stop and/or navigate back to a home base or repair location prior to elapse of the time or distance specified in a time or distance constraint.

Autonomous vehicles can comprise multiple different computing systems that cooperate to control the vehicle. In one example arrangement, an autonomous vehicle may have two PCNs as well as two MCNs. Each of these elements can optionally reside on a different computing device, and each can have a different role in autonomous vehicle control. Furthermore, the computing systems can be connected by a vehicle-based network, so the vehicles can communicate and cooperate to control the autonomous vehicle.

For example, a first PCN may be primarily equipped to perform prediction and planning functions, e.g., computing and selecting vehicle trajectories. A second PCN may be primarily equipped to perform perception functions, e.g., processing sensor inputs to build a representation of an environment surrounding the autonomous vehicle. The representation generated by the second PCN can be used by the first PCN in connection with its prediction and planning functions. Meanwhile, an example first (active) MCN can process selected trajectories produced by the first PCN and can translate the selected trajectories into control instructions for autonomous vehicle systems, such as steering and speed controls. An example second (backup) MCN can remain available in the event that the first MCN experiences a failure, allowing the autonomous vehicle to remain operable by the fully functioning first and second PCNs, even when the first MCN fails.

Autonomous vehicles can also optionally include a collision avoidance system (CAS) which is equipped to take over control of the vehicle in the event that an imminent collision or other imminent danger is detected. In such situations, the CAS may maneuver the vehicle in order to avoid the collision or other danger. The CAS may be implemented across one or more of the PCNs and MCNs.

The techniques described herein can be implemented in a number of ways. Examples are provided below with reference to the following figures. Although discussed in the context of an autonomous vehicle, the methods, apparatuses, and systems described herein can be applied to a variety of systems (e.g., a sensor system or a robotic platform), and are not limited to autonomous vehicles. In examples, similar techniques may be utilized in driver-controlled vehicles in which such a system may provide an indication of whether it is safe to perform various maneuvers.

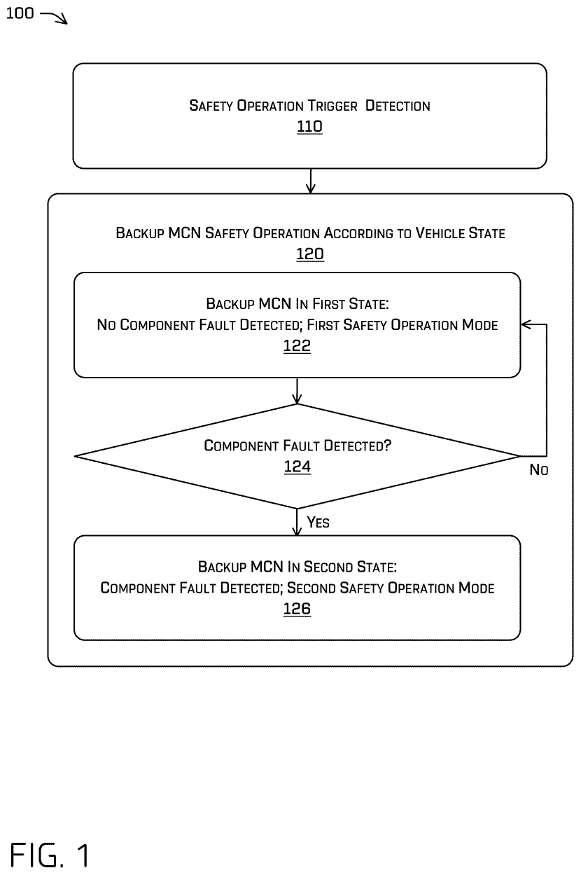

FIG. 1 is a flow diagram illustrating an example process 100 for an autonomous vehicle to respond to a safety operation trigger according to an applicable vehicle state, in accordance with one or more examples of the disclosure. FIG. 1 comprises a block 110 representing a safety operation trigger detection and a block 120 representing a backup MCN safety operation according to a vehicle state. The block 120 comprises a block 122 representing a backup MCN in a first state, a decision block 124 representing possible detection of a component fault, and a block 126 representing the backup MCN in a second state. It should be understood that when the backup MCN is in the first state, the autonomous vehicle is also in a corresponding first vehicle state, and when the backup MCN is in the second state, the autonomous vehicle is also in a corresponding second vehicle state.

In an example according to FIG. 1, the backup MCN may remain in the first state represented by block 122 indefinitely, unless and until a component fault is detected at decision block 124. In the first state, no component fault has been detected, and the autonomous vehicle can respond to safety operation triggers using a first safety operation mode.

The first safety operation mode can comprise, e.g., a no-go mode such as described herein, or any other safety operation mode. In some examples, the first safety operation mode can stop an autonomous vehicle according to one or more safety operation trajectories generated by a PCN. The safety operation trajectories can comprise, e.g., directional components that may involve active steering and velocity components that may involve moderate or variable acceleration/deceleration. The safety operation trajectories can be applied by an active MCN, if available, or otherwise by a backup MCN.

The functionality of one or more vehicle components and systems may be involved in successful deployment of the first safety operation mode, and these vehicle components can be monitored by the autonomous vehicle while in the first state. For example, the backup MCN can be configured to perform component monitoring. Other components, other than those used in the first safety operation mode can also optionally be monitored.

At decision block 124, if no component fault is detected, then the backup MCN and autonomous vehicle can remain in the first state. However, if a component fault is detected, then the backup MCN autonomous vehicle can transition into the second state which uses the second safety operation mode to respond to safety operation triggers.

The autonomous vehicle can transition into the second state, e.g., by discontinuing a first safety operation mode service. Furthermore, the backup MCN can notify the active MCN of the transition. In some implementations, the backup MCN may notify the active MCN that the first safety operation mode is unavailable. Furthermore, depending on the implementation, the backup MCN may or may not notify the PCN of the transition into the second state.

Once the backup MCN and autonomous vehicle have transitioned into the second state represented by block 124, the autonomous vehicle may remain in the second state indefinitely, unless and until the detected component fault is cleared, in which case the autonomous vehicle may optionally transition back to the first state. In the second state the autonomous vehicle can respond to safety operation triggers using the second safety operation mode.

The second safety operation mode can comprise, e.g., a safe stop mode such as described herein, or any other safety operation mode. In some examples, the second safety operation mode can stop an autonomous vehicle according to one or more predetermined settings, rather than according to trajectories generated by a PCN. The predetermined settings can comprise, e.g., a steering angle setting and a braking/deceleration setting. The steering angle setting may hold a same steering angle in use at the time of the safety operation trigger. The deceleration setting may comprise, e.g., a maximum or substantially maximum deceleration of the vehicle.

The predetermined settings can be applied by an active MCN, if available, or otherwise by a backup MCN, in response to a safety operation trigger. One example safety operation trigger is a fault at the active MCN, in which case the backup MCN can assume control of the vehicle and, if the vehicle is in the second state, the backup MCN can apply the second safety operation mode.

The autonomous vehicle can furthermore optionally apply operational constraints while the backup MCN is in the second state. Operational constraints can be applied by the PCN, the active MCN, and/or the backup MCN. In addition to the other operational constraints disclosed herein, example operational constraints can include velocity constraints such as a maximum vehicle velocity, or road type constraints which specify the use of, or exclusion, certain road types (such as highways) for vehicle operation.

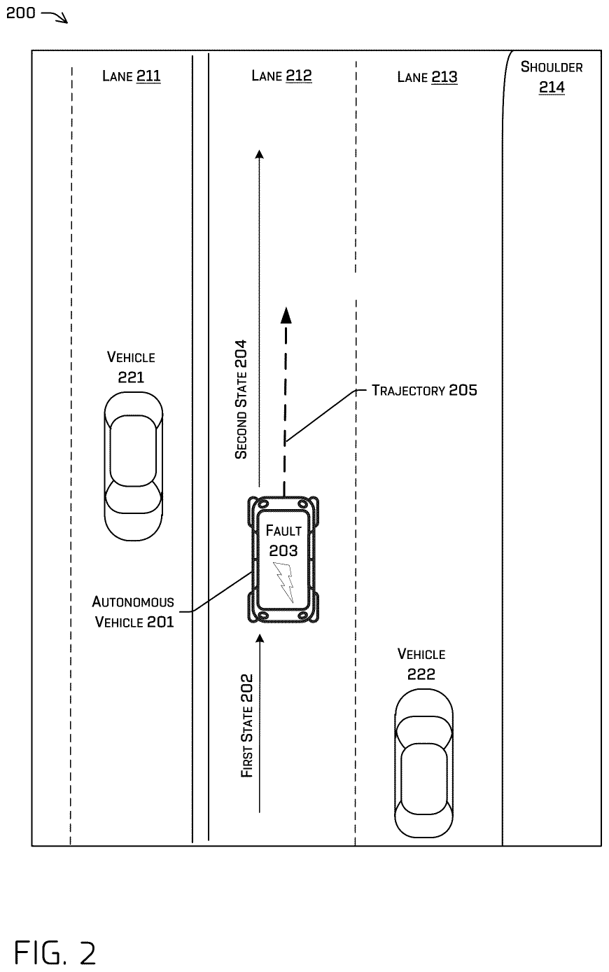

FIG. 2 is a pictorial diagram illustrating an example state transition of an autonomous vehicle which experiences a component fault, wherein different vehicle states are configured to apply different safety operation modes, in accordance with one or more examples of the disclosure. FIG. 2 illustrates an example environment 200 including a first lane 211, a second lane 212, a third lane 213, and a shoulder 214. An autonomous vehicle 201 is traveling in the second lane 212, and the autonomous vehicle 201 has a trajectory 205. Other vehicles 221 and 222 are traveling in the first lane 211 and the third lane 213.

In an example according to FIG. 2, the autonomous vehicle 201 may remain in a first state 202 until such time as the autonomous vehicle 201 experiences a fault 203. The fault 203 may comprise, e.g., a component fault of one or more components on the autonomous vehicle 201. However, in the illustrated example, the fault 203 is not a safety operation trigger, such as a vehicle stopping fault which causes the autonomous vehicle 201 to make an emergency stop. Instead, in response to the fault 203, one or more systems on the autonomous vehicle 201, and the backup MCN in particular, may transition to a second state 204.

In the first state 202, a backup MCN of the autonomous vehicle 201 may be configured to respond to safety operation triggers according to a first safety operation mode. In the second state 204, the backup MCN may be configured to respond to safety operation triggers according to a second safety operation mode. However, in the absence of a safety operation trigger, the autonomous vehicle 201 may proceed on its trajectory 205 and continue its mission, despite the occurrence of the component fault 203, as illustrated in FIG. 2.

Furthermore, in the second state 204 a primary MCN of the autonomous vehicle 201 may be configured to adopt one or more constraints, such as the passenger pickup constraint and/or other constraints as described herein. In an aspect, the autonomous vehicle 201 may be understood as operating under a first set of constraints in the first state 202, while operating under a second, different set of constraints in the second state 204.

In various examples, the component fault 203 can comprise one or more of a trajectory fault, an IMU data fault, a global pose data fault, a local pose data fault, a backup MCN internal fault, a braking fault, a steering fault, and/or a velocity fault. In some cases, the fault 203 may be resolved and the autonomous vehicle 201 may return to the first state 202.

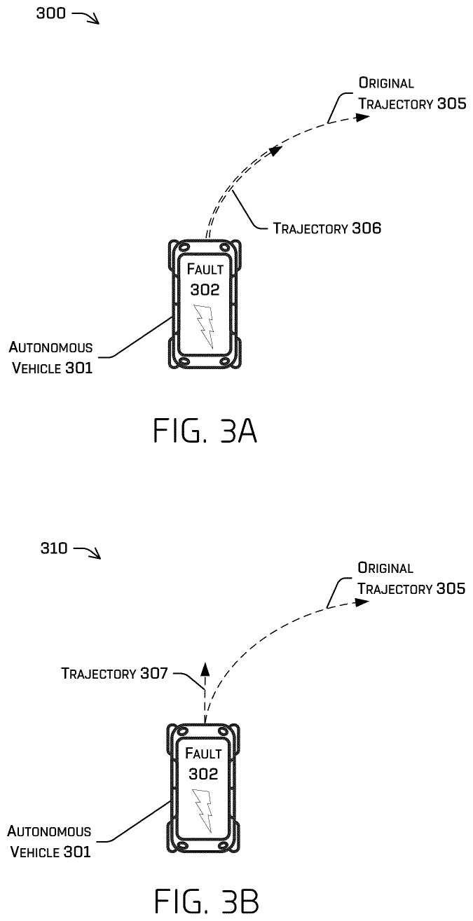

FIGS. 3A-3B are pictorial diagrams illustrating different example safety operation modes for the autonomous vehicle introduced in FIG. 2, in accordance with one or more examples of the disclosure. Both of FIGS. 3A-3B illustrate an example autonomous vehicle 301 having an original trajectory 305. The autonomous vehicle 301 experiences a fault 302. The fault 302 can comprise a safety operation trigger, e.g., a vehicle stopping fault. FIG. 3A shows an example trajectory 306 of the autonomous vehicle 301 according to a first safety operation mode, e.g., a first safety operation mode 300. FIG. 3B shows an example trajectory 307 of the autonomous vehicle 301 according to a second safety operation mode, e.g., a second safety operation mode 310.

As can be observed in FIGS. 3A-3B, the first safety operation mode 300 and the second safety operation mode 310 can potentially produce very different trajectories, such as trajectory 306 and trajectory 307. Different safety operation modes can therefore have a significant impact on trajectory outcomes and corresponding safety of the autonomous vehicle 301.

The autonomous vehicle 301 can be configured to use the first safety operation mode 300 when the autonomous vehicle 301 is in a first vehicle state, e.g., the first state 202 shown in FIG. 2. The autonomous vehicle 301 can be configured to use the second safety operation mode 310 when the autonomous vehicle 301 is in a second vehicle state, e.g., the second state 204 shown in FIG. 2.

The fault 302 can comprise a safety operation trigger. One example safety operation trigger is a fault of an active MCN, which can cause a backup MCN to assume control of the autonomous vehicle 301 and stop the autonomous vehicle 301 according to an applicable safety operation mode. However, other types of faults can also trigger safety operations of the autonomous vehicle 301 and can therefore be considered safety operation triggering faults. The fault 302 can differ from the component fault 203 shown in FIG. 2. The component fault 203 need not require a safety operation such as an emergency stop of the autonomous vehicle 201. In contrast, the fault 302 can trigger an emergency stop or other safety operation of the autonomous vehicle 301.

The first safety operation mode 300 provides an example of the “no-go” stopping mode described herein. In one example application of the first safety operation mode 300, a backup MCN onboard the autonomous vehicle 301 can request a stopping trajectory from a PCN. The PCN can generate and provide one or more stopping trajectories to the backup MCN. The stopping trajectories can optionally comprise active steering and moderate braking, which may potentially avoid obstacles and otherwise accommodate obstacles or other features in an environment of the autonomous vehicle 301. The backup MCN can control the autonomous vehicle 301 according to the stopping trajectories, potentially resulting in a trajectory 306 which may be similar to the original trajectory 305, while exhibiting more deceleration and therefore being shorter than the trajectory 305. The trajectory 306 may also be quite different from a trajectory 307 resulting from application of the second safety operation mode 310.

The second safety operation mode 310 provides an example of the “safe stop” stopping mode described herein. In one example application of the second safety operation mode 310, a backup MCN onboard the autonomous vehicle 301 can apply predetermined steering and braking settings to stop the autonomous vehicle 301. Example predetermined steering and braking settings can optionally comprise maintaining a steering angle which is in place at the time of the fault 302 and applying substantially maximum braking. The second safety operation mode 310 need not necessarily rely on trajectories generated at a PCN, and as a result the second safety operation mode 310 may not account for or avoid obstacles or other features in an environment of the autonomous vehicle 301. The backup MCN can apply the predetermined settings, potentially resulting in a trajectory 307 which may be quite different from the original trajectory 305 and/or the trajectory 306 resulting from application of the first safety operation mode 300.

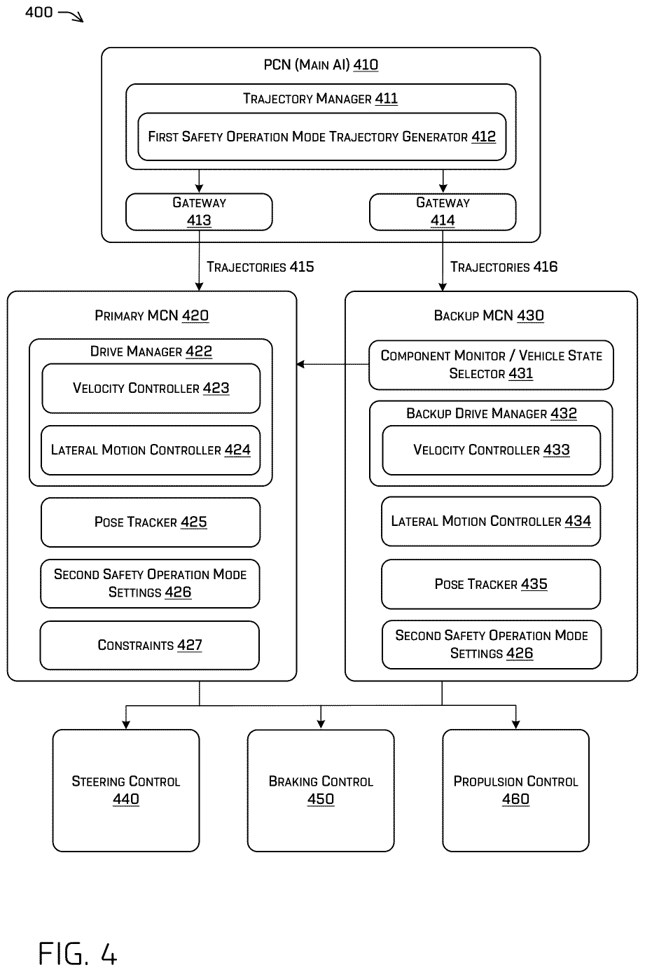

FIG. 4 is a block diagram illustrating an example computing architecture 400 for an autonomous vehicle configured to apply different safety operation modes, in accordance with one or more examples of the disclosure. The computing architecture 400 can be included in an autonomous vehicle 201 or an autonomous vehicle 301, for example. The computing architecture 400 includes a PCN 410, a primary MCN 420, a backup MCN 430, and various vehicle system controllers such as steering controller 440, braking controller 450, and propulsion controller 460. The illustrated components can be connected via a network (not shown in FIG. 4). Sensors such as cameras and LIDAR sensors (not shown in FIG. 4) can also be connected to the network.

The illustrated example PCN 410 can include, among its other functions and components, a trajectory manager 411, a gateway 413, and a gateway 414. The trajectory manager 411 can comprise, inter alia, a first safety operation mode trajectory generator 412.

The illustrated example primary MCN 420 can include, among its other functions and components, a drive manager 422, a pose tracker 425, second safety operation mode settings 426, and constraints 427. The drive manager 422 can include a velocity controller 423 and a lateral motion controller 424.

The illustrated example backup MCN 430 can include, among its other functions and components, a component monitor/vehicle state selector 431, a backup drive manager 432, a lateral motion controller 434, a pose tracker 435, and second safety operation mode settings 426. The backup drive manager 432 can include a velocity controller 433.

In general, the PCN 410 can be configured as a main AI including prediction and planner functions. The PCN 410, or optionally a second PCN (not shown in FIG. 4) can be configured to include vision/perception functions. The PCN 410 can generate trajectories, such as trajectories 415 and trajectories 416, for the autonomous vehicle. The trajectories 415 can be sent to the active MCN 420 via the gateway 413, and the trajectories 416 can be sent to the backup MCN 430 via the gateway 414.

The primary MCN 420 can be configured to control the autonomous vehicle according to trajectories 415 generated by the PCN 410, e.g., by issuing commands to the steering control 440, braking control 450 and propulsion control 460. When the autonomous vehicle is in the first state 202 illustrated in FIG. 2, the primary MCN 420 can be configured to respond to a safety operation trigger by retrieving safety operation trajectories 415 generated by the PCN 410, and the primary MCN 420 can stop the vehicle according to the first safety operation mode. When the autonomous vehicle is in the second state 204 illustrated in FIG. 2, the primary MCN 420 can be configured to respond to a safety operation trigger using the second safety operation mode settings 426 in order to stop the vehicle according to the second safety operation mode.

The backup MCN 430 can be configured to assume control of the autonomous vehicle in the event of safety operation trigger such as a fault or failure at the primary MCN 420. The backup MCN 430 can control the autonomous vehicle according to trajectories 416 generated by the PCN 410, e.g., by issuing commands to the steering control 440, braking control 450 and propulsion control 460. When the autonomous vehicle is in the first state 202 illustrated in FIG. 2, the backup MCN 430 can be configured to respond to a safety operation trigger by retrieving safety operation trajectories 416 generated by the PCN 410, and the backup MCN 430 can stop the vehicle according to the first safety operation mode. When the autonomous vehicle is in the second state 204 illustrated in FIG. 2, the backup MCN 430 can be configured to respond to a safety operation trigger using the second safety operation mode settings 426 in order to stop the vehicle according to the second safety operation mode.

The component monitor/vehicle state selector 431 can be configured to monitor the autonomous vehicle for component faults. If a component fault is detected, the component monitor/vehicle state selector 431 can change the vehicle state from the first state 202 to the second state 204. In order to change the vehicle state, the component monitor/vehicle state selector 431 can optionally be configured to deactivate a first safety operation mode service at the backup MCN 430 and can optionally also notify the primary MCN 420.

In response to a notification from the component monitor/vehicle state selector 431, the primary MCN 420 can optionally deactivate a first safety operation mode at the primary MCN 420. Furthermore, the primary MCN 420 can be configured to apply constraints 427. The constraints 427 can comprise any of the example constraints described herein.

The arrangement of components illustrated in FIG. 4 provides one example only, and this disclosure appreciates that other arrangements are possible. For example, the component monitor/vehicle state selector 431 can be implemented at other locations in the architecture 400 in some embodiments. Furthermore, any of the components of the active MCN 420 and backup MCN 430 can optionally be implemented inside or outside of the drive manager 422 or backup drive manager 432, respectively.

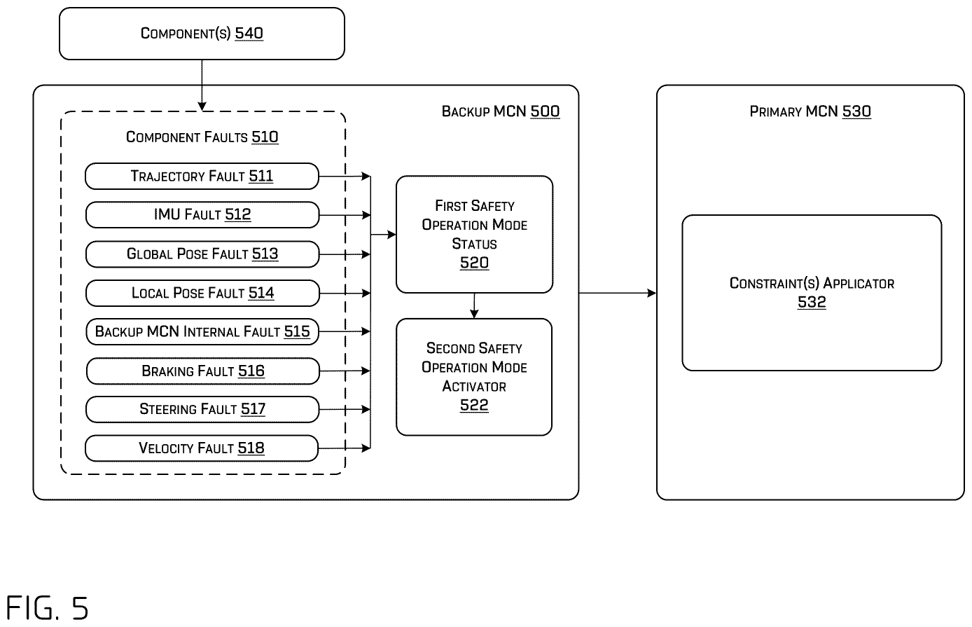

FIG. 5 is a block diagram illustrating example operations of a backup MCN 500 and a primary MCN 530 in connection with applying different safety operation modes, in accordance with one or more examples of the disclosure. FIG. 5 includes the backup MCN 500, the primary MCN 530, and example components 540. The backup MCN 500 and the primary MCN 530 can implement the backup MCN 430 and the primary MCN 420 illustrated in FIG. 4 in some examples. The components 540 can implement, e.g., any autonomous vehicle components, including components implemented with the PCN 410, the steering control 440, braking control 450, propulsion control 460 or other components.

The backup MCN 500 can include received component faults 510, first safety operation mode status 520, and second safety operation mode activator 522. The primary MCN 530 can include constraint(s) applicator 532.

In an example according to FIG. 5, the backup MCN 500 can be configured to monitor components 540, e.g., by receiving or detecting any component faults 510. Example component faults 510 can include a trajectory fault 511, an IMU fault 512, a global pose fault 513, a local pose fault 514, a backup MCN internal fault 515, braking fault 516, a steering fault 517, and/or a velocity fault 518. The illustrated component faults 510 are examples only and different component faults can also trigger safety operation mode changes in other examples.

Prior to receiving or detecting one or more component faults 510, the backup MCN 500 can remain in a first state in which the first safety operation mode status 520 is maintained as “available”, so that the first safety operation mode will be applied in response to any safety operation triggers. In response to receiving or detecting one or more component faults 510, the backup MCN 500 can change the first safety operation mode status 520 to “unavailable”. The backup MCN 500 can optionally use the second safety operation mode activator 522 to activate the second safety operation mode, so that the backup MCN 500 will be reconfigured to use the second safety operation mode in response to any safety operation triggers. Furthermore, the backup MCN 500 can notify the primary MCN 530 to initiate transitioning the primary MCN 530 to the second vehicle state.

Prior to receiving a notification from the backup MCN 500, the primary MCN 530 can remain in a first state. In response to receiving the notification, the primary MCN 530 can transition to a second state and initiate constraints applicator 532 to apply any operational constraints applicable to the second state.

In another aspect, the backup MCN 500 can be configured to monitor divergence between vehicle control decisions that would be made by the backup MCN 500, versus vehicle control decisions made by the primary MCN 530. The divergence can optionally be determined as, e.g., differences in steering angle determinations and/or differences in acceleration/deceleration determinations. Divergence can be measured at multiple separate times, and optionally, at multiple different vehicle velocities. Resulting divergence data can then be used to evaluate differences between backup MCN 500 versus primary MCN 530 control of a vehicle, and, correspondingly, the divergence data can be used to assess the first safety operation mode.

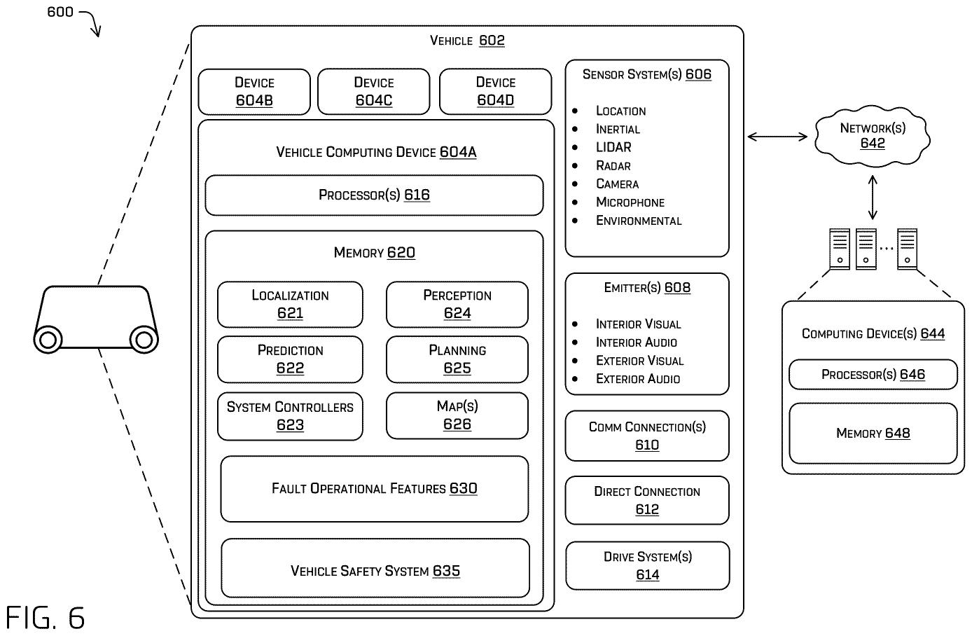

FIG. 6 is a block diagram of an example system 600 including an autonomous vehicle 602, in accordance with one or more examples of the disclosure. The system 600 can include the vehicle 602, which can correspond to an autonomous or semi-autonomous vehicle configured to perform various techniques described herein. As shown in this example, vehicle 602 may include components configured to switch from a first vehicle state to a second vehicle state in response to a component fault at one or more of the vehicle 602 computer systems, and to apply a safety operation mode in accordance with the vehicle state.

The example vehicle 602 can be a driverless vehicle, such as an autonomous vehicle configured to operate according to a Level 6 classification issued by the U.S. National Highway Traffic Safety Administration, which describes a vehicle capable of performing all safety-critical functions for the entire trip, with the driver (or occupant) not being expected to control the vehicle at any time. In such examples, because the vehicle 602 can be configured to control all functions from start to completion of a trip, including all parking functions, it may or may not include a driver and/or controls for driving the vehicle 602, such as a steering wheel, an acceleration pedal, and/or a brake pedal. This is merely an example, and the systems and methods described herein may be incorporated into any ground-borne, airborne, or waterborne vehicle, including those ranging from vehicles that need to be manually controlled by a driver at all times, to those that are partially or fully autonomously controlled.

The vehicle 602 may include vehicle computing devices 604A, 604B, 604C, and 604D, one or more sensor systems 606, one or more emitters 608, one or more communication connections 610, at least one direct connection 612, and one or more drive systems 614.

The vehicle computing devices 604A-D can implement the computing devices described in connection with FIGS. 1-5 in some examples. For example, the vehicle computing devices 604A-D can comprise, e.g., a first PCN, a second PCN, a first (active) MCN, and a second (backup) MCN. Each of the vehicle computing devices 604A-D can include one or more processors and a memory communicatively coupled with the one or more processors. For example, computing device 604A comprises one or more processors 616 and memory 620 communicatively coupled with the one or more processors 616. In the illustrated example, the vehicle 602 is an autonomous vehicle; however, the vehicle 602 could be any other type of vehicle or robotic platform.

In the illustrated example, the memory 620 of the vehicle computing device 604A can store various functions such as a localization component 621, a prediction component 622, system controllers 623, a perception component 624, a planning component 625, and one or more maps 626. Some of the example functions 621-526 can be implemented on, e.g., the vehicle computing device 604A while others of the example functions 621-526 can be implemented on, e.g., another of the vehicle computing devices 604B-D. The vehicle computing device 604A can furthermore comprise, e.g., fault operational features 630 and a vehicle safety system 635.

Though depicted in FIG. 6 as residing in the memory 620 for illustrative purposes, one or more of the localization component 621, prediction component 622, system controllers 623, perception component 624, planning component 625, maps 626, fail operational features 630, and vehicle safety system 635 can additionally, or alternatively, be accessible to the vehicle 602 (e.g., stored on, or otherwise accessible by, memory remote from the vehicle 602).

As shown in this example, the vehicle 602 also may also include a vehicle safety system 635, such as a collision avoidance system. The vehicle safety system 635 may be configured to generate, validate, and select an output trajectory for the vehicle 602. For instance, the vehicle safety system 635 may include a trajectory manager, which may include one or more trajectory generator(s), one or more trajectory validator(s), and/or a trajectory selector. The vehicle safety system 635 can optionally be implemented separately from the fault operational features 630 disclosed herein.

By way of example, the vehicle computing device 604A may be considered to be a primary system, while the fault operational features 630 and the vehicle safety system 635 may be considered to be secondary systems. The primary system may generally perform processing to control how the vehicle maneuvers within an environment. The primary system within the vehicle computing device 604A may implement various artificial intelligence (AI) techniques, such as machine learning, to understand an environment around the vehicle 602 and/or instruct the vehicle 602 to move within the environment. The various components of the primary system, such as the localization component 621, prediction component 622, perception component 624, and planning component 625 may implement AI techniques to localize the vehicle, detect objects around the vehicle, segment sensor data, determine classifications of the objects, predict object tracks, generate trajectories for the vehicle 602 and the objects around the vehicle, and so on. In some examples, the primary system may process data from multiple types of sensors on the vehicle, such as light detection and ranging (lidar) sensors, radar sensors, image sensors, depth sensors (time of flight, structured light, etc.), cameras, and the like, within the sensor systems 606.

The fault operational features 630 and vehicle safety system 635 in this example may operate as separate systems that receive state data (e.g., perception data) based on the sensor data and AI techniques implemented by the primary system (e.g., vehicle computing device 604A), and may perform various techniques described herein for improving vehicle safety and operation, such as selecting a vehicle state and performing safety operations according to the selected vehicle state, or collision prediction and avoidance. The fault operational features 630 and vehicle safety system 635 may implement techniques for determining predicted trajectories and predicting intersections/collisions based on the predicted trajectories, as well as probabilistic techniques that are based on positioning, velocity, acceleration, etc. of the vehicle and/or objects around the vehicle.

In some examples, the fault operational features 630 and vehicle safety system 635 may process data from sensors, such as a subset of sensor data that is processed by the primary system. To illustrate, the primary system may process lidar data, radar data, image data, depth data, etc., while the fault operational features 630 and vehicle safety system 635 may process just lidar data and/or radar data (and/or time of flight data). In other examples, however, the fault operational features 630 and vehicle safety system 635 may process sensor data from any number of sensors, such as data from each of the sensors, data from the same number of sensors as the primary system, etc.

Although depicted in FIG. 6 as residing in the memory 620 for illustrative purposes, it is contemplated that the localization component 621, prediction component 622, system controllers 623, perception component 624, planning component 625, maps 626, and fault operational features 630 may additionally, or alternatively, be accessible to the vehicle 602 (e.g., stored on, or otherwise accessible by, memory remote from the vehicle 602, such as, for example, on memory 654 of a remote computing device 644).

In at least one example, the localization component 621 may include functionality to receive data from the sensor system(s) 606 to determine a position and/or orientation of the vehicle 602 (e.g., one or more of an x-, y-, z-position, roll, pitch, or yaw). For example, the localization component 621 may include and/or request/receive a map of an environment and may continuously determine a location and/or orientation of the autonomous vehicle within the map. In some instances, the localization component 621 may utilize SLAM (simultaneous localization and mapping), CLAMS (calibration, localization and mapping, simultaneously), relative SLAM, bundle adjustment, non-linear least squares optimization, or the like to receive image data, LIDAR data, radar data, IMU data, GPS data, wheel encoder data, and the like to accurately determine a location of the autonomous vehicle. In some instances, the localization component 621 may provide data to various components of the vehicle 602 to determine an initial position and/or trajectory of the vehicle 602, as discussed herein.

In some instances, and in general, the perception component 624 can include functionality to perform object detection, segmentation, and/or classification. In some examples, the perception component 624 can provide processed sensor data that indicates a presence of an entity that is proximate to the vehicle 602 and/or a classification of the entity as an entity type (e.g., car, pedestrian, cyclist, animal, building, tree, road surface, curb, sidewalk, stoplight, stop sign, unknown, etc.).

In additional or alternative examples, the perception component 624 can provide processed sensor data that indicates one or more characteristics associated with a detected entity (e.g., a tracked object) and/or the environment in which the entity is positioned. In some examples, characteristics associated with an entity can include, but are not limited to, an x-position (global and/or local position), a y-position (global and/or local position), a z-position (global and/or local position), an orientation (e.g., a roll, pitch, yaw), an entity type (e.g., a classification), a velocity of the entity, an acceleration of the entity, an extent of the entity (size), etc. Characteristics associated with the environment can include, but are not limited to, a presence of another entity in the environment, a state of another entity in the environment, a time of day, a day of a week, a season, a weather condition, an indication of darkness/light, etc.

In general, the prediction component 622 can include functionality to generate predicted information associated with objects in an environment. As an example, the prediction component 622 can be implemented to predict locations of a pedestrian proximate to a crosswalk region (or otherwise a region or location associated with a pedestrian crossing a road) in an environment as they traverse or prepare to traverse through the crosswalk region.

As another example, the techniques discussed herein can be implemented to predict locations of other objects (e.g., vehicles, bicycles, pedestrians, and the like) as the vehicle 602 traverses an environment. In some examples, the prediction component 622 can generate one or more predicted positions, predicted velocities, predicted trajectories, etc., for such target objects based on attributes of the target object and/or other objects proximate the target object.

In general, the planning component 625 can determine a path for the vehicle 602 to follow to traverse the environment. The planning component 625 can include functionality to determine various routes and trajectories and various levels of detail. For example, the planning component 625 can determine a route to travel from a first location (e.g., a current location) to a second location (e.g., a target location). For the purpose of this discussion, a route can be a sequence of waypoints for travelling between two locations. As non-limiting examples, waypoints include streets, intersections, global positioning system (GPS) coordinates, etc.

Further, the planning component 625 can generate an instruction for guiding the autonomous vehicle along at least a portion of the route from the first location to the second location. In at least one example, the planning component 625 can determine how to guide the autonomous vehicle from a first waypoint in the sequence of waypoints to a second waypoint in the sequence of waypoints. In some examples, the instruction can be a trajectory, or a portion of a trajectory. In some examples, multiple trajectories can be substantially simultaneously generated (e.g., within technical tolerances) in accordance with a receding horizon technique, wherein one of the multiple trajectories is selected for the vehicle 602 to navigate.

In some instances, the planning component 625 can generate one or more trajectories for the vehicle 602 based at least in part on predicted location(s) associated with object(s) in an environment. In some examples, the planning component 625 can use temporal logic, such as linear temporal logic and/or signal temporal logic, to evaluate one or more trajectories of the vehicle 602.

In at least one example, the vehicle computing device 604A can include one or more system controllers 623, which can be configured to control steering, propulsion, braking, safety, emitters, communication, and other systems of the vehicle 602. These system controller(s) 623 can communicate with and/or control corresponding systems of the drive system(s) 614 and/or other components of the vehicle 602.

For example, the planning component 625 may generate instructions based at least in part on perception data generated by the perception component 624 and transmit the instructions to the system controller(s) 623, which may control operation of the vehicle 602 based at least in part on the instructions. In some examples, if the planning component 625 receives a notification that a track of an object was “lost” (e.g., an object no longer appears in perception data and isn't occluded by any other objects), the planning component 625 may generate an instruction to bring the vehicle 602 to a safe stop and/or to transmit a request for teleoperator assistance.

The memory 620 can further include one or more maps 626 that can be used by the vehicle 602 to navigate within the environment. For the purpose of this disclosure, a map can be any number of data structures modeled in two dimensions, three dimensions, or N-dimensions that are capable of providing information about an environment, such as, but not limited to, topologies (such as intersections), streets, mountain ranges, roads, terrain, and the environment in general.

In some instances, a map can include, but is not limited to: texture information (e.g., color information (e.g., RGB color information, Lab color information, HSV/HSL color information), and the like), intensity information (e.g., lidar information, radar information, and the like); spatial information (e.g., vectorized information regarding features of an environment, image data projected onto a mesh, individual “surfels” (e.g., polygons associated with individual color and/or intensity)), reflectivity information (e.g., specularity information, retroreflectivity information, BRDF information, BSSRDF information, and the like). In one example, a map can include a three dimensional mesh of the environment. In some instances, the map can be stored in a tiled format, such that individual tiles of the map represent a discrete portion of an environment and can be loaded into working memory as needed. In at least one example, the one or more maps 626 can include at least one map (e.g., images and/or a mesh).

In some examples, the vehicle 602 can be controlled based at least in part on the maps 626. That is, the maps 626 can be used in connection with the localization component 621, the perception component 624, the prediction component 622, and/or the planning component 625 to determine a location of the vehicle 602, identify objects in an environment, and/or generate routes and/or trajectories to navigate within an environment. In some examples, the one or more maps 626 can be stored on a remote computing device(s), such as within the memory 648 of the computing device(s) 644 and may be accessible to the vehicle 602 via network(s) 642. In some examples, multiple maps 626 can be retrieved from the memory 648, and stored based on, for example, a characteristic (e.g., type of entity, time of day, day of week, season of the year, etc.). Storing multiple maps 626 can have similar memory requirements but can increase the speed at which data in a map can be accessed.

In at least one example, the fault operational features 630 may include functionality to determine, by a first vehicle computing device 604A, whether a component fault has occurred at either the first vehicle computing device 604A or at another of the vehicle computing devices 604B-D. Furthermore, the fault operational features 630 may include functionality to transition the vehicle 602 from a first vehicle state to a second vehicle state in response to the component fault.

The fault operational features 630 may furthermore include functionality to determine, by the first vehicle computing device 604A, whether a safety operation trigger has occurred at either the first vehicle computing device 604A or at another of the vehicle computing devices 604B-D. The safety operation trigger can comprise, e.g., a fault or failure at either the first vehicle computing device 604A or at another of the vehicle computing devices 604B-D. The fault operational features 630 may comprise functionality to control the vehicle 602 in a manner that brings the vehicle 602 to a stop using a safety operation mode applicable to a corresponding vehicle state.

In an example technical approach, the fault operational features 630 can be configured to determine component faults by monitoring fault logs generated by vehicle computing devices 604A-D. The vehicle computing devices 604A-D can be configured to log any fault conditions that occur, including for example fault types, fault times, and affected systems. The fault operational features 630 can monitor such logs continuously or periodically, and when a fault occurs, the fault operational features 630 can transition the vehicle 602 from a first vehicle state to second vehicle state.

In another example technical approach, the fault operational features 630 can be configured to monitor heartbeat signals output from other vehicle computing devices 604B-D. If a computing device stops producing its heartbeat signal as expected, then the fault determination component 631 can be configured to determine that a safety operation trigger has occurred and a safety operation is needed.

As can be understood, the components discussed herein (e.g., localization component 621, prediction component 622, system controllers 623, perception component 624, planning component 625, maps 626, and fault operational features 630) are described as divided for illustrative purposes. However, the operations performed by the various components can be combined or performed in any other component. Further, any of the components discussed as being implemented in software can be implemented in hardware, and vice versa. Further, any functionality implemented in the vehicle 602 can be implemented in the computing device(s) 644, or another component (and vice versa).

In at least one example, the sensor system(s) 606 can include time of flight sensors, lidar sensors, radar devices and/or radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, etc.), microphones, wheel encoders, environment sensors (e.g., temperature sensors, humidity sensors, light sensors, pressure sensors, etc.), etc.

The sensor system(s) 606 can include multiple instances of each of these or other types of sensors. For instance, the time-of-flight sensors can include individual time of flight sensors located at the corners, front, back, sides, and/or top of the vehicle 602. As another example, the camera sensors can include multiple cameras disposed at various locations about the exterior and/or interior of the vehicle 602.

The sensor system(s) 606 can provide input to the vehicle computing devices 604A-D. Additionally or alternatively, the sensor system(s) 606 can send sensor data, via the one or more networks 642, to the one or more computing device(s) 644 at a particular frequency, after a lapse of a predetermined period of time, in near real-time, etc.

The vehicle 602 can also include one or more emitters 608 for emitting light and/or sound, as described above. The emitters 608 in this example include interior audio and visual emitters to communicate with passengers of the vehicle 602. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like.

The emitters 608 in this example also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 602 can also include one or more communication connection(s) 610 that enable communication between the vehicle 602 and one or more other local or remote computing device(s). For instance, the communication connection(s) 610 can facilitate communication with other local computing device(s) on the vehicle 602 and/or the drive system(s) 614. Also, the communication connection(s) 610 can allow the vehicle to communicate with other nearby computing device(s) (e.g., other nearby vehicles, traffic signals, etc.). The communications connection(s) 610 also enable the vehicle 602 to communicate with a remote teleoperation computing device or other remote services.

The communications connection(s) 610 can include physical and/or logical interfaces for connecting the vehicle computing devices 604A-D to another computing device or a network, such as network(s) 642. For example, the communications connection(s) 610 can enable Wi-Fi-based communication such as via frequencies defined by the IEEE 802.11 standards, short range wireless frequencies such as Bluetooth®, cellular communication (e.g., 2G, 3G, 4G, 4G LTE, 6G, etc.) or any suitable wired or wireless communications protocol that enables the respective computing device to interface with the other computing device(s).

In at least one example, the vehicle 602 can include one or more drive systems 614. The vehicle 602 can have a single drive system 614, or multiple drive systems 614. In at least one example, if the vehicle 602 has multiple drive systems 614, individual drive systems 614 can be positioned on opposite ends of the vehicle 602 (e.g., the front and the rear, etc.).

In at least one example, the drive system(s) 614 can include one or more sensor systems to detect conditions of the drive system(s) 614 and/or the surroundings of the vehicle 602. By way of example and not limitation, the sensor system(s) can include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive system, lidar sensors, radar sensors, etc. Some sensors, such as the wheel encoders can be unique to the drive system(s) 614. In some cases, the sensor system(s) on the drive system(s) 614 can overlap or supplement corresponding systems of the vehicle 602 (e.g., sensor system(s) 606).

The drive system(s) 614 can include many of the vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.).

Additionally, the drive system(s) 614 can include a drive system controller which can receive and preprocess data from the sensor system(s) and to control operation of the various vehicle systems. In some examples, the drive system controller can include one or more processors and memory communicatively coupled with the one or more processors. The memory can store one or more components to perform various functionalities of the drive system(s) 614. Furthermore, the drive system(s) 614 also include one or more communication connection(s) that enable communication by the respective drive system with one or more other local or remote computing device(s).

In at least one example, the direct connection 612 can provide a physical interface to couple the one or more drive system(s) 614 with the body of the vehicle 602. For example, the direct connection 612 can allow the transfer of energy, fluids, air, data, etc. between the drive system(s) 614 and the vehicle 602. In some instances, the direct connection 612 can further releasably secure the drive system(s) 614 to the body of the vehicle 602.

In at least one example, the localization component 621, the perception component 624, the prediction component 622, the planning component 625, the system controllers 623, and the maps 626, can process sensor data, as described above, and can send their respective outputs, over the one or more network(s) 642, to one or more computing device(s) 644. In at least one example, the respective outputs of the components can be transmitted to the one or more computing device(s) 644 at a particular frequency, after a lapse of a predetermined period of time, in near real-time, etc.

Additionally, or alternatively, the vehicle 602 can send sensor data to one or more computing device(s) 644 via the network(s) 642, including raw sensor data, processed sensor data and/or representations of sensor data. Such sensor data can be sent as one or more log files to the computing device(s) 644 at a particular frequency, after a lapse of a predetermined period of time, in near real-time, etc.

The computing device(s) 644 can include processor(s) 646 and a memory 648. In some examples, a state machine repository in the memory 648 may store one or more state transition models that can be generated and modified offline and provided to various vehicles 602 in a fleet. Different state transition models may be provided to different models of vehicles 602, and/or based on the location or operating conditions of the vehicles 602.

In various examples, the computing devices 644 may implement one or more machine learning systems or heuristics-based systems to train, test, and optimize different state transition models for different vehicles 602 operating within different environments. Additionally, any of the features or functionalities described in connection with the vehicle fail operational features 630 may be performed by computing devices 644.

The processor(s) 616 of the vehicle 602 and the processor(s) 646 of the computing device(s) 644 can be any suitable processor capable of executing instructions to process data and perform operations as described herein. By way of example and not limitation, the processor(s) 616 and 646 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

Memory 620 and 648 are examples of non-transitory computer-readable media. The memory 620 and 648 can store an operating system and one or more software applications, instructions, programs, and/or data to implement the methods described herein and the functions attributed to the various systems. In various examples, the memory can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

It should be noted that while FIG. 6 is illustrated as a distributed system, in alternative examples, components of the vehicle 602 can be associated with the computing device(s) 644 and/or components of the computing device(s) 644 can be associated with the vehicle 602. That is, the vehicle 602 can perform one or more of the functions associated with the computing device(s) 644, and vice versa.

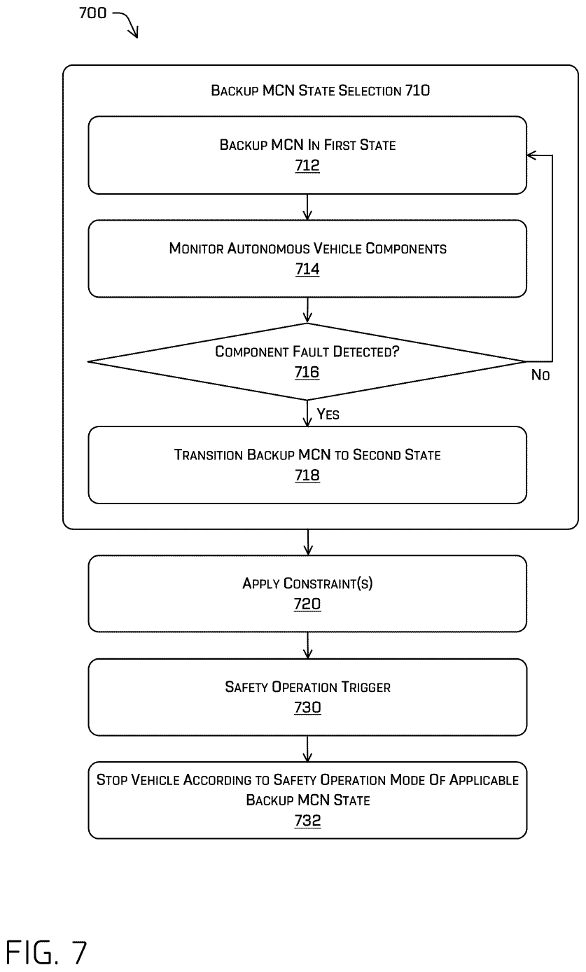

FIG. 7 is a flow diagram illustrating an example process for an autonomous vehicle to switch between different vehicle states, the different vehicle states having different safety operation modes, in accordance with one or more examples of the disclosure. As described below, the process 700 may be performed by one or more computer-based components configured to implement various functionalities described herein.

The process 700 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures, or environments.

The process 700 can be performed by an autonomous vehicle 201 such as illustrated in FIG. 2, wherein the autonomous vehicle 201 is equipped with a computing architecture 400 such as illustrated in FIG. 4. For example, the autonomous vehicle 201 can be equipped with a first MCN (the primary MCN 420) and a second MCN (the backup MCN 430). The second MCN is a backup MCN 430 configured to activate in response to a safety operation trigger. Meanwhile, the second MCN can monitor for component faults, and can transition the autonomous vehicle 201 from a first state to a second state in response to component fault detection.

The process 700 includes two stages. First, while the autonomous vehicle 201 is operating and before any safety operation trigger occurs, the process 700 can comprise vehicle state selection 710 and related operations. Second, if and when a safety operation trigger occurs at operation 730, then at operation 732 the autonomous vehicle 201 can stop according to a vehicle stopping mode of an applicable vehicle state.

Vehicle state selection 710 can comprise operations 712-718. At operation 712, the backup MCN of an autonomous vehicle 201 can remain in a first state. The first state can comprise a nominal state wherein no fault has been detected and all vehicle systems are considered operational. Should a safety operation trigger occur at operation 730 when the autonomous vehicle 201 remains in the first state, the computing architecture 400 can be configured to perform safety operation according to a first safety operation mode. The first safety operation mode can generally apply more vehicle maneuvering decisions/functions than the second safety operation mode.

For example, in the first safety operation mode, the autonomous vehicle 201 can be configured to apply a computed stopping trajectory that is generated at the PCN 410. The computed stopping trajectory can comprise an active steering trajectory that includes, e.g., one or more second steering angles different from a first steering angle at a time of the safety operation trigger. The computed stopping trajectory can alternatively, or additionally comprise a “moderate” deceleration, e.g., a deceleration which is at least ten percent below a maximum deceleration of the autonomous vehicle 201. The computed stopping trajectory can optionally comprise a shortened trajectory which is shorter than one or more other trajectories used by the autonomous vehicle 201.

While the autonomous vehicle 201 remains in the first state according to operation 712, the autonomous vehicle 201 can monitor autonomous vehicle components at operation 714. Monitoring can optionally be performed by any of the elements of the computing architecture 400. In some examples, monitoring can be performed by the backup MCN 430 in order to detect component faults, such as the example component faults 510 illustrated in FIG. 5.

Operation 716 illustrates that, if no component fault is detected pursuant to the monitoring at operation 714, then the autonomous vehicle 201 can remain in the first state according to operation 712. However, should a component fault be detected pursuant to the monitoring at operation 714, then the backup MCN of the autonomous vehicle 201 can transition into a second state as per operation 718.

The second state can comprise a reduced function state wherein a component fault has been detected and so one or more vehicle systems is considered to be compromised. Should a safety operation trigger occur at operation 730 when the autonomous vehicle 201 is in the second state, the computing architecture 400 can be configured to perform a safety operation according to a second safety operation mode which is different from the first safety operation mode. The second safety operation mode can generally apply fewer vehicle maneuvering decisions/functions than the first safety operation mode. For example, the second safety operation mode can apply predetermined brake and steering settings, such as the second safety operation mode settings 426, without following a computed stopping trajectory.

At operation 720, while in the second state, the autonomous vehicle 201 can furthermore be configured to apply one or more constraints on autonomous vehicle operations. The one or more constraints can comprise, e.g., one or more of a passenger pickup constraint which limits passenger pickups by the autonomous vehicle 201, or a time constraint which limits an amount of time before an autonomous vehicle 201 stop. Any other constraints disclosed herein or otherwise may also be applied in connection with some implementations of this disclosure.

### EXAMPLE CLAUSES

A. A vehicle comprising: a first computer system comprising a primary compute node configured to generate trajectories for the vehicle; a second computer system comprising a first motion compute node configured to control the vehicle to follow the trajectories; and a third computer system comprising a second motion compute node configured to control the vehicle to follow the trajectories in response to a safety operation trigger comprising a fault at the first motion compute node; wherein each of the first, second, and third computer systems comprises one or more processors and one or more computer-readable media storing computer-executable instructions; wherein the instructions, when executed, implement an autonomous driving system that is configured for autonomous control of the vehicle; and wherein the instructions, when executed, cause the first, second and third computer systems to perform operations comprising: monitoring, by the second motion compute node, one or more vehicle components; in response to operability of one or more components, remaining, by the second motion compute node, in a first state wherein the second motion compute node uses a first safety operation mode in response to the safety operation trigger; and in response to a component fault at the one or more components, transitioning, by the second motion compute node, to a second state wherein the second motion compute node uses a second safety operation mode in response to the safety operation trigger.
B. The system of paragraph A, wherein in the first safety operation mode, the second motion compute node follows a stopping trajectory computed by the primary compute node, and wherein in the second safety operation mode, the second motion compute node applies predetermined brake and steering settings without following the stopping trajectory computed by the primary compute node.
C. The system of paragraph B, wherein the stopping trajectory comprises an active steering trajectory that includes a second steering angle different from a first steering angle at a time of the safety operation trigger, and wherein the stopping trajectory comprises a first deceleration less than a second deceleration used in the second safety operation mode.
D. The system of paragraph A, the operations further comprising, in the second state, applying one or more constraints on vehicle operations.
E. A method comprising: monitoring, in an autonomous vehicle equipped with at least two different safety operation modes, one or more autonomous vehicle components; in response to operability of the one or more autonomous vehicle components, initially remaining, by a backup motion compute node of autonomous vehicle, in a first state wherein the autonomous vehicle responds to a safety operation trigger using a first safety operation mode; and subsequent to remaining in the first state, and in response to a component fault at the one or more autonomous vehicle components, transitioning, by the backup motion compute node, to a second state wherein the autonomous vehicle responds to the safety operation trigger using a second safety operation mode different from the first safety operation mode.
F. The method of paragraph E, wherein the autonomous vehicle is equipped with a primary motion compute node and the backup motion compute node, wherein the backup motion compute node is configured to activate in response to the safety operation trigger, and wherein the monitoring is performed at the backup motion compute node.
G. The method of paragraph E, wherein, in the first safety operation mode, the autonomous vehicle applies a computed stopping trajectory, and in the second safety operation mode, the autonomous vehicle applies predetermined brake and steering settings without following the computed stopping trajectory.
H. The method of paragraph G, wherein the computed stopping trajectory comprises an active steering trajectory that includes a second steering angle different from a first steering angle at a time of the safety operation trigger.
I. The method of paragraph G, wherein the computed stopping trajectory comprises a deceleration which is at least ten percent below a maximum deceleration of the autonomous vehicle.
J. The method of paragraph G, wherein the computed stopping trajectory comprises a shortened trajectory which is shorter than one or more other trajectories used by the autonomous vehicle.
K. The method of paragraph E, further comprising, subsequent to remaining in the first state, and in response to the component fault at the one or more autonomous vehicle components, applying one or more constraints on autonomous vehicle operations.
L. The method of paragraph K, wherein the one or more constraints comprise one or more of a passenger pickup constraint which limits passenger pickups by the autonomous vehicle, or a time constraint which limits an amount of time before an autonomous vehicle stop.
M. One or more non-transitory computer-readable media storing instructions executable by a processor, wherein the instructions, when executed, cause the processor to perform operations comprising: monitoring one or more components of an autonomous vehicle; in response to operability of the one or more components, causing a backup motion compute node of the autonomous vehicle to remain in a first state wherein the autonomous vehicle responds to a safety operation trigger using a first safety operation mode; and in response to a component fault at the one or more components, transitioning the backup motion compute node into a second state wherein the autonomous vehicle responds to the safety operation trigger using a second safety operation mode.
N. The one or more non-transitory computer-readable media of paragraph M, wherein the autonomous vehicle is equipped with a primary motion compute node and the backup motion compute node, wherein the backup motion compute node is configured to activate in response to the safety operation trigger, and wherein the monitoring is performed at the backup motion compute node,
P. The one or more non-transitory computer-readable media of paragraph M, wherein, in the first safety operation mode, the autonomous vehicle follows a computed trajectory, and in the second safety operation mode, the autonomous vehicle applies a predetermined steering setting without following the computed trajectory.
O. The one or more non-transitory computer-readable media of paragraph P, wherein the computed trajectory comprises an active steering trajectory that includes a second steering angle different from a first steering angle at a time of the fault.
Q. The one or more non-transitory computer-readable media of paragraph P, wherein the computed trajectory comprises a first deceleration which is below a second deceleration used in the second safety operation mode.
R. The one or more non-transitory computer-readable media of paragraph P, wherein the computed trajectory comprises a shortened trajectory which is shorter than one or more other trajectories used by the autonomous vehicle.
S. The one or more non-transitory computer-readable media of paragraph M, wherein the operations further comprise applying, in response to the component fault, one or more constraints on autonomous vehicle operations.
T. The one or more non-transitory computer-readable media of paragraph S, wherein the one or more constraints comprise one or more of a passenger pickup constraint which limits passenger pickups by the autonomous vehicle, or a time constraint which limits an amount of time before an autonomous vehicle stop.

While the example clauses described above are described with respect to particular examples, it should be understood that, in the context of this document, the content of the example clauses can be implemented via a method, device, system, a computer-readable medium, and/or another example. Additionally, any of examples A-T may be implemented alone or in combination with any other one or more of the examples A-T.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate examples are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A vehicle comprising:
a first computer system comprising a primary compute node configured to generate trajectories for the vehicle;
a second computer system comprising a first motion compute node configured to control the vehicle to follow the trajectories; and
a third computer system comprising a second motion compute node configured to control the vehicle to follow the trajectories in response to a safety operation trigger comprising a fault at the first motion compute node;
wherein each of the first, second, and third computer systems comprises one or more processors and one or more computer-readable media storing computer-executable instructions;
wherein the instructions, when executed, implement an autonomous driving system that is configured for autonomous control of the vehicle; and
wherein the instructions, when executed, cause the first, second and third computer systems to perform operations comprising:
monitoring, by the second motion compute node, one or more vehicle components;
in response to operability of one or more components, remaining, by the second motion compute node, in a first state wherein the second motion compute node uses a first safety operation mode in response to the safety operation trigger; and
in response to a detection of a component fault at the one or more components, transitioning, by the second motion compute node, to a second state wherein the second motion compute node uses a second safety operation mode in response to the safety operation trigger.

2. The vehicle of claim 1, wherein in the first safety operation mode, the second motion compute node follows a stopping trajectory computed by the primary compute node, and wherein in the second safety operation mode, the second motion compute node applies predetermined brake and steering settings without following the stopping trajectory computed by the primary compute node.

3. The vehicle of claim 2, wherein the stopping trajectory comprises an active steering trajectory that includes a second steering angle different from a first steering angle at a time of the safety operation trigger, and wherein the stopping trajectory comprises a first deceleration less than a second deceleration used in the second safety operation mode.

4. The vehicle of claim 1, the operations further comprising, in the second state, applying one or more constraints on vehicle operations.

5. A method comprising:
monitoring, in an autonomous vehicle equipped with at least two different safety operation modes, one or more autonomous vehicle components;
in response to operability of the one or more autonomous vehicle components, initially remaining, by a backup motion compute node of the autonomous vehicle, in a first state wherein the autonomous vehicle responds to a safety operation trigger using a first safety operation mode; and
subsequent to remaining in the first state, and in response to a detection of a component fault at the one or more autonomous vehicle components, transitioning, by the backup motion compute node, to a second state wherein the autonomous vehicle responds to the safety operation trigger using a second safety operation mode different from the first safety operation mode.

6. The method of claim 5, wherein the autonomous vehicle is equipped with a primary motion compute node and the backup motion compute node, wherein the backup motion compute node is configured to activate in response to the safety operation trigger, and wherein the monitoring is performed at the backup motion compute node.

7. The method of claim 5, wherein, in the first safety operation mode, the autonomous vehicle applies a computed stopping trajectory, and in the second safety operation mode, the autonomous vehicle applies predetermined brake and steering settings without following the computed stopping trajectory.

8. The method of claim 7, wherein the computed stopping trajectory comprises an active steering trajectory that includes a second steering angle different from a first steering angle at a time of the safety operation trigger.

9. The method of claim 7, wherein the computed stopping trajectory comprises a deceleration which is at least ten percent below a maximum deceleration of the autonomous vehicle.

10. The method of claim 7, wherein the computed stopping trajectory comprises a shortened trajectory which is shorter than one or more other trajectories used by the autonomous vehicle.

11. The method of claim 5, further comprising, subsequent to remaining in the first state, and in response to the component fault at the one or more autonomous vehicle components, applying one or more constraints on autonomous vehicle operations.

12. The method of claim 11, wherein the one or more constraints comprise one or more of a passenger pickup constraint which limits passenger pickups by the autonomous vehicle, or a time constraint which limits an amount of time before an autonomous vehicle stop.

13. One or more non-transitory computer-readable media storing instructions executable by a processor, wherein the instructions, when executed, cause the processor to perform operations comprising:
monitoring one or more components of an autonomous vehicle;
in response to operability of the one or more components, causing a backup motion compute node of the autonomous vehicle to remain in a first state wherein the autonomous vehicle responds to a safety operation trigger using a first safety operation mode; and
in response to a detection of a component fault at the one or more components, transitioning the backup motion compute node into a second state wherein the autonomous vehicle responds to the safety operation trigger using a second safety operation mode.

14. The one or more non-transitory computer-readable media of claim 13, wherein the autonomous vehicle is equipped with a primary motion compute node and the backup motion compute node, wherein the backup motion compute node is configured to activate in response to the safety operation trigger, and wherein the monitoring is performed at the backup motion compute node.

15. The one or more non-transitory computer-readable media of claim 13, wherein, in the first safety operation mode, the autonomous vehicle follows a computed trajectory, and in the second safety operation mode, the autonomous vehicle applies a predetermined steering setting without following the computed trajectory.

16. The one or more non-transitory computer-readable media of claim 15, wherein the computed trajectory comprises an active steering trajectory that includes a second steering angle different from a first steering angle at a time of the fault.

17. The one or more non-transitory computer-readable media of claim 15, wherein the computed trajectory comprises a first deceleration which is below a second deceleration used in the second safety operation mode.

18. The one or more non-transitory computer-readable media of claim 15, wherein the computed trajectory comprises a shortened trajectory which is shorter than one or more other trajectories used by the autonomous vehicle.

19. The one or more non-transitory computer-readable media of claim 13, wherein the operations further comprise applying, in response to the component fault, one or more constraints on autonomous vehicle operations.

20. The one or more non-transitory computer-readable media of claim 19, wherein the one or more constraints comprise one or more of a passenger pickup constraint which limits passenger pickups by the autonomous vehicle, or a time constraint which limits an amount of time before an autonomous vehicle stop.
